(19) United States
(12) Patent Application Publication
(10) Pub. No.: US 2024/0121769 A1
(43) Pub. Date: Apr. 11, 2024

(54) METHOD, DEVICE, AND SYSTEM FOR TRANSMISSION CONTROL PARAMETERS UPDATE IN WIRELESS NETWORKS

(71) Applicant: ZTE Corporation, Shenzhen (CN)

(72) Inventors: Xiaoying MA, Shenzhen (CN); Jun XU, Shenzhen (CN); Mengzhu CHEN, Shenzhen (CN); Yuzhou HU, Shenzhen (CN); Hong TANG, Shenzhen (CN); Jiajun XU, Shenzhen (CN)

(73) Assignee: ZTE Corporation, Shenzhen, GD (CN)

(21) Appl. No.: 18/539,729

(22) Filed: Dec. 14, 2023

Related U.S. Application Data
(63) Continuation of application No. PCT/CN2021/111162, filed on Aug. 6, 2021.

(51) Int. Cl. H04W 72/11; H04L 1/00; H04L 1/1812; H04L 5/00; H04W 72/12

(52) U.S. Cl. CPC H04W 72/11; H04L 1/0003; H04L 1/1812; H04L 5/0051; H04W 72/12

(57) ABSTRACT

This disclosure relates generally to transmitting and receiving signaling for transmission control parameter update in wireless communications. Performed by a wireless terminal in a wireless network, the method including transmitting feedback information to a wireless communication node in the wireless network via a first message, the feedback information being used for adjusting a transmission control parameter for a transmission associated with the wireless terminal, and the transmission comprising at least one of a semi persistent scheduling (SPS) transmission or a configured grant (CG) scheduling transmission.

### TECHNICAL FIELD

This disclosure is directed generally to wireless communications, and particularly to a method, device, and system for transmitting and receiving signaling for transmission control parameter.

### BACKGROUND

With the development of wireless communication technology, the transmission rate, delay, throughput, reliability and other performance indexes of wireless communication system have been greatly improved by using high frequency band, large bandwidth, multi-antenna and other technologies. Currently, eXtended Reality (XR) and Cloud Gaming are some important 5G media applications under consideration and study in the industry. XR includes representative forms such as Augmented Reality (AR), Mixed Reality (MR), Virtual Reality (VR), and areas interpolated among them. It is critical for XR and Cloud Gaming service to meet the requirement of high reliability, high throughput, and low latency.

### SUMMARY

This disclosure is directed to a method, device, and system for transmission control parameters update of various types in wireless communications. In some embodiments, a method performed by a wireless terminal in a wireless network is disclosed. The method may include transmitting feedback information to a wireless communication node in the wireless network via a first message, the feedback information being used for adjusting a transmission control parameter for a transmission associated with the wireless terminal, and the transmission comprising at least one of a semi persistent scheduling (SPS) transmission or a configured grant (CG) scheduling transmission.

In some embodiments, a method performed by a wireless communication node in a wireless network is disclosed. The method may include receiving feedback information from a wireless terminal in the wireless network via a first message, wherein the feedback information is based on transmission control parameter adjustment configuration.

In some embodiments, there is a wireless communication terminal and/or a wireless communication node comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

The above embodiments and other aspects and alternatives of their implementations are described in greater detail in the drawings, the descriptions, and the claims below.

### BRIEF DESCRIPTION OF THE DRAWINGS

FIG. 1 shows an example wireless communication network.

FIG. 2 shows an example SPS configuration.

FIG. 3 shows an example CG configuration.

FIG. 4 shows an example embodiment for adjusting transmission control parameter.

FIG. 5 shows an example in which the feedback information is based on two transmission control parameter adjustment configurations.

FIG. 6 shows an example configuration for the feedback information transmission.

FIG. 7 shows an example search space set configuration and a feedback information configuration.

FIG. 8 shows an example search space set configuration and a SPS configuration.

### DETAILED DESCRIPTION

### Wireless Communication Network

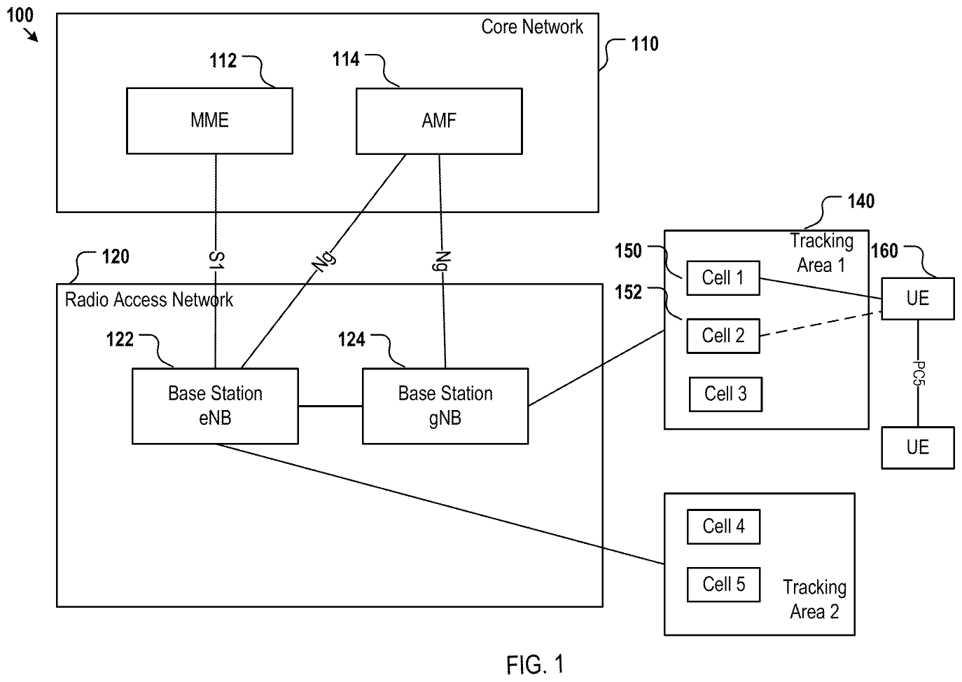

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may support sidelink communication to another UE via a PC5 interface.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

### Transmission Resource Scheduling

The wireless network may support different types of traffic, such as voice traffic, streaming video traffic, Extended Reality (XR) and cloud gaming traffic, etc. The traffic may be categorized as uplink (UL) traffic and downlink (DL) traffic. Different traffic scheduling schemes are deployed to support different types of traffic. Among these schemes, Semi Persistent Scheduling (SPS) and Configured Grant (CG) are suitable for XR and cloud gaming traffic. In particular, SPS may reduce the number of Downlink Control Information (DCI) required compared with dynamic scheduling for DL packets. CG may reduce the transmission latency because UE does not need to transmit a Scheduling Request (SR) or a Buffer Status Report (BSR) and wait for a UL grant transmitted from the base station.

### SPS

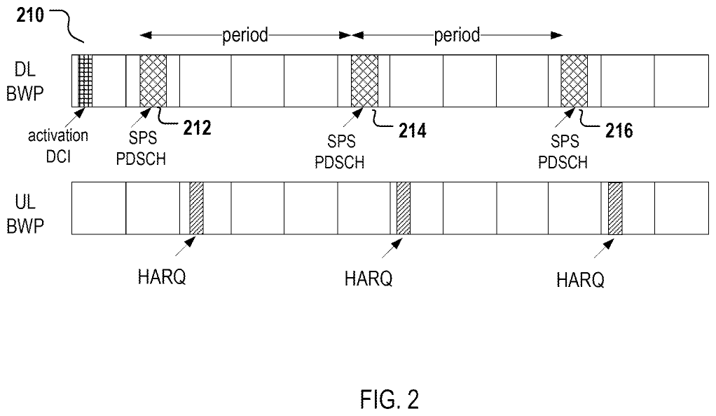

FIG. 2 shows an example SPS configuration. In SPS, the base station configures the Physical Downlink Shared Channel (PDSCH) with SPS configuration such as Modulation and Coding Scheme (MCS) table, MCS index, modulation order, repetition number, aggregation number, Transmission Control Information (TCI), TCI table, Sounding Reference Signal (SRS) Resource Indicator (SRI), frequency domain resource, time domain resource (e.g., periodic information), etc. The SPS configuration may be done by Radio Resource Control (RRC) signaling.

In some embodiments, the SPS configuration, once configured, may be enabled or activated without further indication.

In some embodiments, the SPS configuration may need to be enabled, or activated by an indication. For example, a DCI 210 scrambled with a Configured Scheduling—Radio Network Temporary Identifier (CS-RNTI) maybe used to activate the SPS configuration. In some embodiments, the same DCI may also indicate other information such as Physical Downlink Shared Channel to Hybrid Automatic Repeat reQuest feedback (PDSCH-to-HARQ_feedback) timing indicator, time domain resource assignment indication, and MCS Index, repetition number, aggregation number, Transmission Control Information (TCI), TCI table, or Sounding Reference Signal (SRS) Resource Indicator (SRI). The DCI may then trigger a first PDSCH transmission 212. Subsequent PDSCH transmissions 214, and 216 will arrive periodically according the corresponding activated SPS configuration, without further indication by additional DCI.

### CG

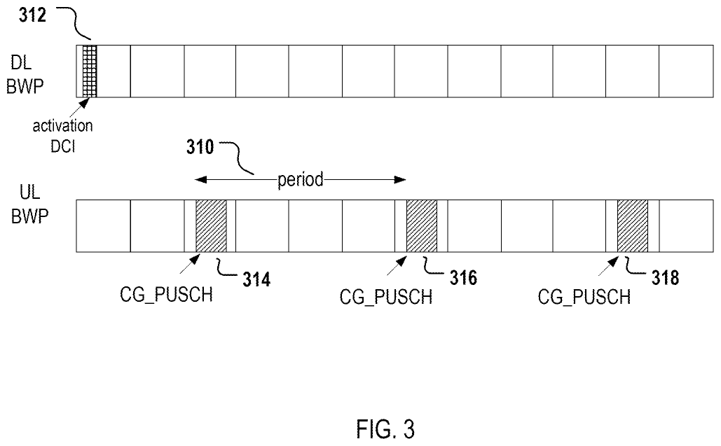

FIG. 3 shows an example CG configuration. In CG scheduling, a Physical Uplink Shared Channel (PUSCH) periodicity 310 may be configured along with other CG configurations. The UE transmits PUSCH periodically based on the periodicity, without a need for DCI scheduling. The CG configuration includes MCS table, frequency resource, periodicity, and so on. The CG configuration may be done by higher layer signaling such as RRC signaling.

The CG scheduling method includes Type-1 CG configuration and Type-2 CG configuration. If a Type-1 CG is configured, the CG configuration does not need to be explicitly activated and the UE can transmit PUSCH in resource as defined by the CG configuration. If a Type-2 CG is configured, the CG configuration needs to be activated, for example, by a DCI 312, before the UE can transmit PUSCH in resource as defined by the CG configuration, such as 314, 316, and 318.

### MCS

The MCS of a PDSCH may be determined according to an index and an MCS table. The index may be indicated in ‘Modulation and Coding Scheme’ field in a DCI. The MCS table may be determined according to an RRC configuration, an RNTI, or a DCI format. An index to the MCS table may indicate a row in a MCS table. Each row in an MCS table may include an index, a modulation order, a target code rate, and a spectral efficiency.

As described above, the SPS configuration and the CG configuration are pre-configured, for example, by RRC signaling. The pre-determined SPS configuration and CG configuration may work well for a particular traffic characteristic or a channel condition. However, in a situation where the traffic characteristic or the channel condition changes quickly, they may not be able to adapt to the change thus negatively impact the transmission quality and/or efficiency.

For example, in SPS scheduling, other than the first PDSCH, the subsequent PDSCH does not need a DCI. SPS configuration parameters, such as the MCS of the PDSCH will stay the same once indicated by the activation DCI. An activation DCI is a DCI activating a SPS configuration or CG configuration. If the channel condition changes quickly, the MCS may no longer match the new channel condition and the PDSCH may not be decoded correctly. It is thus desirable to be able to change the configuration parameters to adapt to the new channel condition promptly, while still maintain the already configured SPS session. The same principle also applies to CG session. The dynamic update of the configuration parameters applies to parameters other than the MCS, which is used merely as an example.

In this disclosure, various embodiments for adjusting the SPS configuration or the CG configuration on the fly is disclosed. The UE may proactively send feedback information to the base station, so the base station may make a quick and informed adjustment to the SPS or CG configuration based on the feedback information. The base station may then further notify the UE about the decision on the adjustment and the UE may apply or activate the adjustment.

### UE Assisted Transmission Control Parameter Update

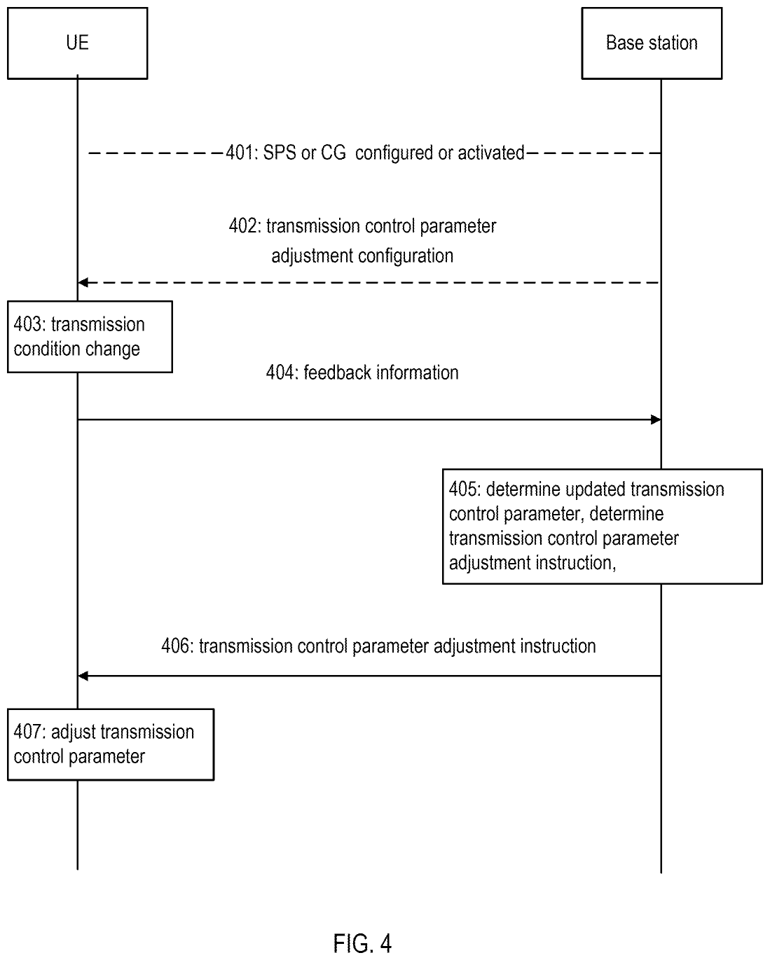

FIG. 4 illustrates an example in which feedback information is used to adjust a transmission control parameter associated with SPS or CG.

Step 401: The UE is configured with a SPS or a CG configuration. The configuration may be activated.

Step 402: Base station sends transmission control parameter adjustment configuration to the UE. With reference to the transmission control parameter adjustment configuration along with other information, the UE is able to determine feedback information. More details on the transmission control parameter adjustment configuration will be described below.

Step 403: During the SPS or CG session, there is a transmission condition change, or a traffic characteristic change, or some other types of change which impact the transmission. UE detects this change and determines the feedback information based on the transmission control parameter adjustment configuration. In some embodiments, UE may determine the feedback information based on other criteria and under other conditions. There is no limitation on when on how the UE determine the feedback information.

Step 404: UE sends feedback information to the base station, to inform the base station an information used for adjusting the transmission control parameter.

Step 405: Base station may determine an updated transmission control parameter, or transmission control parameter adjustment instruction, based on the feedback information. In some embodiments, the base station may also determine the updated transmission control parameter based on other factors and without the need of the feedback information.

Step 406: Base station sends the updated transmission control parameter, or the transmission control parameter adjustment instruction to the UE.

Step 407: Based on the information received in step 406, UE adjusts the transmission control parameter.

After step 407, the UE and the base station will sync up on the updated transmission control parameter. In particular, the UE may effectuate the transmission control parameter immediately, in a next slot, or with a delay. In some implementations, the base station may send an activation DCI to instruct the UE to activate the updated transmission control parameter. In some embodiments, it is possible that after the UE sends the feedback information, the UE and the base station start to use the updated transmission control parameter, without any further handshake. In some embodiments, it is also possible that the base station, upon receiving the feedback information, explicitly instruct the UE not to apply the recommended update. In some embodiments, the base station may send updated transmission control parameter by considering other factors other than the feedback information.

### Transmission Control Parameter Adjustment Configuration

The feedback information as shown in FIG. 4 indicates an updated transmission control parameter which is preferred or recommended by the UE. In some implementations, the UE may directly indicate (or send) the recommended transmission control parameter to the base station, such as a new MCS index, a CQI, or any other parameters associated with the SPS configuration or CG configuration. In some implementations, the feedback information includes a CQI.

In some implementations, to at least save signaling overhead, rather than sending the transmission control parameter itself, the UE may choose to send information with smaller footprint to indicate the transmission control parameter. For example, a delta value (or referred to as a modification value) may be sent and an updated transmission control parameter may be derived from the delta value together with the latest (or currently applied) transmission control parameter. For example, UE may send in the feedback information a delta value −1. If the current MCS index is 10, then the updated MCS index may be derived as 10−1=9 It is also to be understood that the concept of delta value applies to other parameters, in addition to the example MCS index. Further, the UE may send the delta value directly, or use a bitmap to map different delta values. The mapping may be predetermined and agreed upon between the UE and the base station. The mapping may also be signaled between the base station and the UE. Refer to Table 1 below for a sample mapping.

TABLE 1
Delta value mapping table

| Bits | |
|---|---|
| representing | Delta |
| delta value | value |
| 00 | 1 |
| 01 | 2 |
| 10 | 4 |
| 11 | 8 |

In addition to delta value, the feedback information may also carry: a percentage; a step value; or a fallback information. In particular, the percentage and the step value may be used to calculate the updated transmission control parameter based on a reference value. The reference value may include a value of the currently configured transmission control parameter, a lastly used transmission control parameter, etc. The fallback information indicates a fallback to a predetermined configuration, such as a lowest MCS index or a predetermined MCS index. All the aforementioned information may similarly be represented by a bitmap. Mixed information may also be combined to be represented in a bitmap.

A step value may be used to derive an updated transmission control parameter. For example, a single step may be defined as 2, so 3 steps indicate a change of 6. For another example, a single step may be defined as −3, so 2 steps indicate a change of −6.

In this disclosure, for the purpose of simplicity, examples may be given using delta value. The same concept may be used for step value, percentage value, and other parameters in the transmission control parameter adjustment configuration, as the goal is to derive an updated transmission control parameter from the feedback information, which is based on the transmission control parameter adjustment configuration.

In some embodiments, an MCS ID (also referred to as MCS index) modification value may be used as the delta value. The MCS ID may be updated according to the delta value. For example, MCS_ID=MCS_ID_{ref}+MCS_ID_{mod}. In this equation, MCS_ID is the MCS Index for subsequent SPS PDSCH or CG-PUSCH transmission, MCS_ID_{ref} is a reference MCS ID, MCS_ID_{mod} is the MCS ID modification value (i.e., the delta value).

In some embodiments, the reference MCS ID includes at least one of the following: an MCS index of a current PDSCH configuration; an MCS index of a current CG-PUSCH configuration; an MCS index indicated or activated by a DCI; a lastly applied MCS index in a SPS session or a CG session; or an MCS index configured by an RRC signaling.

In some embodiments, a percentage value may be carried in the feedback information to indicate a desired percentage change on the transmission control parameter. For example, MCS_ID=MCS_ID_{ref}*(1+MCS_ID_{percentage}). MCS_ID_{percentage} represents the percentage value. The MCS_ID may be rounded to an integer after applying the percentage change, for example, by performing a floor or ceiling operation.

In some embodiments, the Channel Quality Information (CQI) may be used to estimate or determine a desired transmission control parameter such as an MCS index. By applying similar concept, the UE may use the feedback information to carry a desired CQI change. For example, a delta CQI index or a percentage value may be carried in the feedback information. For example, CQI=CQI_{ref}+CQI_{mod}. In this equation, CQI is the update CQI, CQIref is a reference CQI, CQI_{mod} is the delta CQI. In some embodiments, once the base station derives the CQI from the feedback information, the base station may further determine and indicate to the UE an updated MCS index according to the CQI. In some embodiments, the reference CQI includes a wideband CQI Index.

In some embodiments, an aggregation number is the number of consecutive symbols or slots in which PDSCH or PUSCH is transmitted. In another word, a packet may be split and transmitted in the aggregation number of symbols or slots, which correspond to X PDSCH transmissions or X PUSCH transmissions, with X being the aggregation number. Every PDSCH or PUSCH transmission in the aggregation may use same frequency domain resource setting.

In some embodiments, a repetition number is the number of times a that packet transmission is repeated in one or more PDSCH or PUSCH resource.

The time and frequency resource for SPS PDSCH or CG-PUSCH is allocated by the base station and may not be changed by UE. If the size of the to-be-transmitted packet is a variable, the resource allocated for a single SPS PDSCH or CG-PUSCH may be wasted or may be not enough for a packet. Therefore, if the packet size is small and the resource is enough for more than one packet, the packet bit (payload) may be transmitted with repetition in the resource, to improve transmission reliability and fully utilize the transmission resource. In some other scenarios, a packet may have to be split and transmitted in multiple PDSCH or PUSCH (i.e., aggregation).

In some embodiments, if the MCS index is updated, the resource needed for an original packet may also change. In this scenario, the UE may send a delta repetition number, or the delta aggregation number via the feedback information. For example, repetitionnumber=RP_{ref}+RP_{mod}. The repetition number is used for following SPS PDSCH or CG-PUSCH, RP_{ref} is a reference number, and RP_{mod} is the delta repetition number.

In some embodiments, the delta value in the feedback information includes a delta value for codepoints in the transmission configuration information (TCI) field of a DCI. For example, the codepoints in the “transmission configuration information” field of an activation DCI is ‘01’ which indicates a TCI-state with index 1, the delta value is 1, then the update TCI-state is according to the codepoints which is ‘10’ and indicates a TCI-state with index 2. In another example, the updated TCI-state is according to the codepoints which is 01+1=10 (bit operation).

A TCI field in a DCI indicates a TCI state from a list of TCI state. Each TCI-State contains parameters for configuring a quasi co-location relationship between one or two downlink reference signals and the DM-RS ports of the PDSCH, the DM-RS port of PDCCH or the Channel State Information Reference Signal (CSI-RS) port(s) of a CSI-RS resource. The codepoint to which the TCI State is mapped is determined by its ordinal position among all the TCI States with Ti field set to 1. Ti field is the field that indicates the activation/deactivation status of a TCI state with TCI-Stateld i.

In some embodiments, a delta value in the feedback information is a delta value for a TCI-state index.

In some embodiments, a delta value in the feedback information is a delta value for a Sounding Reference Signal (SRS) resource indicator. One SRI indicates one or more SRS resources.

In this disclosure, a transmission control parameter adjustment configuration is disclosed. The transmission control parameter adjustment configuration includes configuration information to facilitate transmission control parameter update. For example, the transmission control parameter adjustment configuration may include a list of delta MCS index, a list of steps, a list of percentages, a list of fallback information, a list of delta repetition number, a list of delta aggregation number, etc. The UE may choose a value from the list which the UE recommends to apply to a transmission control parameter and sends the value via the feedback information to the base station.

The transmission control parameter adjustment configuration may correspond to at least one SPS identifier. One SPS configuration corresponds to one transmission control parameter adjustment configuration.

The transmission control parameter adjustment configuration may correspond to at least one CG identifier. One CG configuration is corresponds to one transmission control parameter adjustment configuration.

In some embodiments, the transmission control parameter adjustment configuration may be predetermined, for example, based on a protocol upon which both the UE and the base station follow. In some embodiments, the base station may send the transmission control parameter adjustment configuration to the UE via a message, for example, an RRC message or a Media Access Control—Control Element (MAC CE) message. The RRC message may further carry a list of delta value; an enable information; one or more SPS ID to which the transmission control parameter adjustment configuration applies; and one or more CG ID to which the transmission control parameter adjustment configuration applies. The RRC message may further include a bit number. The bit number is the number of bits the UE should use in feedback information (or message carrying the feedback information).

In some embodiments, the RRC message may include multiple transmission control parameter adjustment configuration each applies to a particular type of feedback information. For example, the RRC message may configure two transmission control parameter adjustment configurations to the UE, and UE may configure two types of feedback information based on the corresponding transmission control parameter adjustment configuration. For another example, one transmission control parameter adjustment configuration is used for first M feedback information and the first M feedback information are transmitted after the PDSCH or PUSCH which is scheduled by an activation DCI. For another example, the first M feedback information are transmitted after a Physical Random Access Channel (PRACH) procedure. For another example, the first M feedback information are transmitted after a Msg 4, a Msg 2, a Msg 3, or a Msg B. In some embodiments, M=1. In some embodiments, the number of delta values in one transmission control parameter adjustment configuration is larger than or equal to the number of delta values in another transmission control parameter adjustment configuration. In some embodiments, each transmission control parameter adjustment configuration may correspond to a different priority.

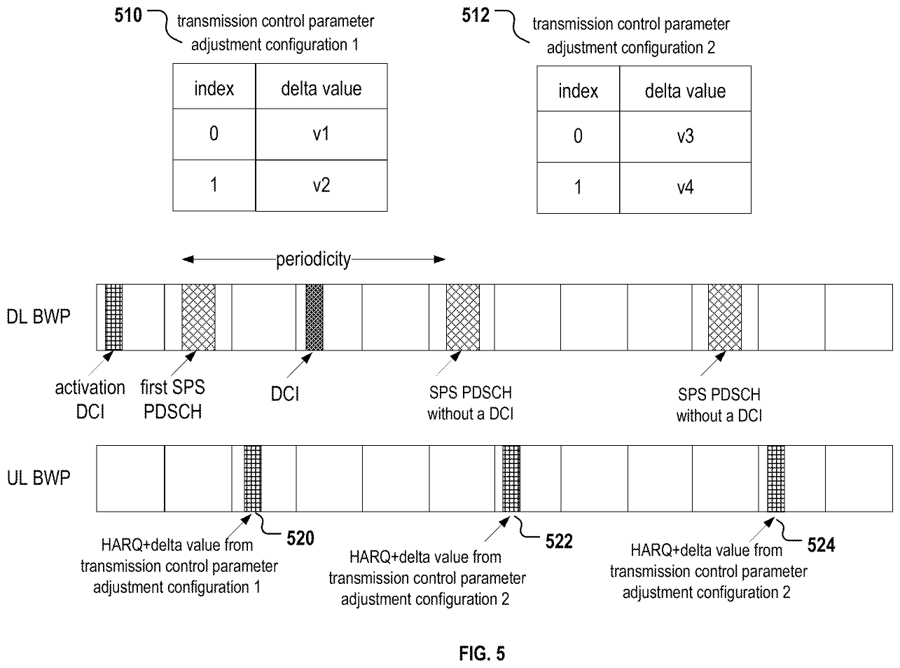

Referring to FIGS. 5, 510 and 512 are two example transmission control parameter adjustment configuration each includes different delta values. 520 is feedback information based on transmission control parameter adjustment configuration 1 (510). 522 and 524 are feedback information based on transmission control parameter adjustment configuration 2 (512).

In some embodiments, each transmission control parameter adjustment configuration may be associated with one or more SPS ID, or CG ID. Each transmission control parameter adjustment configuration may apply to different SPS session or CG session.

In some embodiments, the RRC message may include only one transmission control parameter adjustment configuration which includes only one delta value list. Based on the timing or enable condition of the feedback information, the delta value may need further modification, such as being multiplied by a factor. For example, the delta value in the feedback message transmitted right after the PDSCH or PUSCH which is scheduled by an activation DCI will be multiplied by the factor. Delta values received in other occasions may be used directly to derive updated parameter. The factor may be predefined or configured by RRC signaling, and is greater than or equal to one. In another example, the factor is greater than 0 and less than one.

In some embodiments, the RRC message may include only one transmission control parameter adjustment configuration which includes only one delta value list. The delta value list may be divided into 2 sub-lists. Based on the timing or enable condition of the feedback information, one of the sub-lists may be chosen. For example, for the feedback message transmitted right after the PDSCH or PUSCH which is scheduled by an activation DCI, the first sub-list may be chosen. The second sub-list may be used for feedback information transmitted on other occasions. In some embodiments, the number of delta values in the first sub-list is great than or equal to the number of delta values in the second sub-list.

In some embodiments, the RRC message is configured per SPS configuration. In some embodiments, the RRC message is configured per CG configuration. In some embodiments, the RRC signaling may be configured per Bandwidth Part (BWP) configuration, per MAC configuration, per UE configuration, or per serving cell configuration. For example, the RRC message contains delta values for MCS index, and the RRC signaling is configured per SPS configuration. For another example, the RRC message contains delta values for CQI, and the RRC signaling is configured per UE configuration or per serving cell configuration. The same goal may also be achieved by using a single RRC message, but with multiple segments. Alternatively, a single transmission control parameter adjustment configuration may be divided into multiple segments, each serving, for example, an SPS configuration.

In some embodiments, the transmission control parameter adjustment configuration may further include a fallback information. The fallback information means fallback to the lowest index of MCS or a pre-configured fallback MCS index. For example, if the fallback information is configured, the UE may transmit a feedback information to indicate fallback to the lowest index of MCS. The feedback information may be transmitted via an Uplink Control Information (UCI). In some embodiments, the feedback information may be transmitted via a CG-UCI.

In some embodiments, the various types parameters in transmission control parameter adjustment configuration may be combined or joint coded. For example, the UE may transmit a a feedback information to indicate fallback to the lowest index of MCS, and a delta MCS index. For another example, two bits in UCI may be used to carry the feedback information. ‘00’ indicates the fallback information, ‘01’ indicates the first delta MCS index, ‘10’ indicates the second delta MCS index, ‘11’ indicates the third delta MCS index.

In some embodiments, the base station may explicitly enable or allow the UE to transmit feedback information. In some embodiments, the base station may explicitly disable or restrict the UE from sending feedback information. In some embodiments, the base station may explicitly enable or allow the UE to transmit feedback information according to an enable condition. In some embodiments, the enable condition includes receiving an indication from the base station via an RRC signaling or a DCI. In some embodiments, the indication is an enable information or an enable indication or a configuration signaling.

In some embodiments, an enable condition may be associated with at least one of:
a Signal to Noise or Interference Ratio (SINR);
a Reference Signal Received Power (RSRP);
a Channel State Information (CSI) information;
a trigger signaling;
a PDSCH reception without a corresponding PDCCH;
a PUSCH without a corresponding PDCCH;
a block error rate (BLER);
a HARQ transmission number;
a (Negative ACKnowledgment) (NACK); or
a retransmission number.

In some embodiments, the RRC signaling, or the transmission control parameter adjustment configuration may include a bit number. The bit number is the number of bits allocated for a feedback information. For example, the number of bits allocated in a UCI carrying the feedback information.

In some embodiments, in addition to the RRC message, the transmission control parameter adjustment configuration may also be transmitted using a high layer signaling such as a Media Access Control—Control Element (MAC CE) signaling.

### Feedback Information

As shown in FIG. 4, step 404, UE transmits feedback information to the base station. In some embodiments, the feedback information may be transmitted via a UCI. The feedback information indicates a recommended update to a transmission control parameter. The feedback information may be used for adjusting a transmission control parameter. The feedback information may carry a parameter from the transmission control parameter adjustment configuration, for example, a delta value, a step value, or a percentage. These values may be applied to various transmission control parameters, such as MCS index, CQI, etc.

In some embodiments, an enable condition may be associated with at least an SINR. Whether or not transmit a feedback information is determined according to at least an SINR. For example, if current SINR is less than a target SINR or a predefined threshold, UE may transmit a feedback information, otherwise, UE may not transmit a feedback information. In another example, if SINR is changed, UE may transmit a feedback information, otherwise, UE may not transmit a feedback information.

In some embodiments, an enable condition may be associated with at least a RSRP. Whether or not transmit a feedback information is determined according to at least a RSRP. For example, if RSRP is less than a predefined threshold, UE may transmit a feedback information, otherwise, UE may not transmit a feedback information. In another example, if RSRP is changed, UE may transmit a feedback information, otherwise, UE may not transmit a feedback information.

In some embodiments, an enable condition may be associated with at least a trigger signaling. Whether or not transmit a feedback information is determined according to at least a trigger signaling. For example, if UE receives the trigger signaling, UE may transmit a feedback information, otherwise, UE may not transmit a feedback information. The trigger signaling may be a DCI or a high layer signaling. In some embodiments, the trigger signaling is an activation DCI.

In some embodiments, an enable condition may be associated with at least a PDSCH reception without a corresponding PDCCH. Whether or not transmit a feedback information is determined according to at least a PDSCH reception without a corresponding PDCCH. For example, if UE receives a PDSCH reception without a corresponding PDCCH, UE may transmit a feedback information, otherwise, UE may not transmit a feedback information.

In some embodiments, an enable condition may be associated with at least a PUSCH without a corresponding PDCCH. Whether or not transmit a feedback information is determined according to at least a PUSCH without a corresponding PDCCH. For example, if UE transmits a PUSCH without a corresponding PDCCH, UE may transmit a feedback information, otherwise, UE may not transmit a feedback information.

In some embodiments, an enable condition may be associated with at least a BLER. Whether or not transmit a feedback information is determined according to at least a BLER. For example, if current BLER is less than target BLER or a predefined threshold, UE may transmit a feedback information, otherwise, UE may not transmit a feedback information.

In some embodiments, an enable condition may be associated with at least a HARQ transmission number. Whether or not transmit a feedback information is determined according to at least a HARQ transmission number. For example, if the HARQ transmission number is less than a predefined threshold, UE may transmit a feedback information, otherwise, UE may not transmit a feedback information. Predefined threshold is an integer value greater than 0 and less than 10 (e.g., 3).

In some embodiments, an enable condition may be associated with at least a NACK. Whether or not transmit a feedback information is determined according to at least a NACK. For example, if UE would transmit a NACK for a SPS PDSCH, UE may transmit a feedback information, otherwise, UE may not transmit a feedback information.

In some embodiments, an enable condition may be associated with at least a retransmission number. Whether or not transmit a feedback information is determined according to at least a retransmission number. For example, if a SPS PDSCH retransmit number is greater than a threshold, UE may transmit a feedback information, otherwise, UE may not transmit a feedback information. The threshold is an integer value greater than 0 and less than 10 (e.g., 3).

### Transmit Occasion for Feedback Information

In some embodiments, the transmission configuration of the feedback information may be configured via an RRC signaling which includes at least one of: a periodicity, an offset, a duration, a SPS index (or configuration), a reference point, a PUCCH resource, a prohibit timer value, a CG index (or configuration).

A SPS index (or configuration) may be associated with (or include) a periodicity of a SPS configuration, an offset, a time domain resource allocation information, etc. A CG index (or configuration) may be associated with (or include) a periodicity of a CG configuration, an offset, a time domain resource allocation information, etc.

The feedback information can be transmitted periodically based on the periodicity. The periodicity may be in the unit of slot, or milliseconds, etc. In some embodiments, the periodicity may be associated with at least one of the following: a DRX cycle, a periodicity of a SPS configuration associated with the transmission, a periodicity of a CG configuration associated with the transmission, a speed of a traffic (e.g., Frame per Second (FPS)), a high layer signaling.

In some embodiments, the periodicity (denoted as P_feedback) may be associated with a periodicity of a SPS configuration (P_SPS). P_feedback may be P_SPS multiplied by a factor M. The factor is greater than zero. For example, P_feedback=M*P_SPS. M is an integer greater than or equal to 1. For another example, P_feedback=M*P_SPS. M is an integer greater than 0 and less than or equal to 1.

In some embodiments, the periodicity may be associated with a periodicity of a CG configuration (P_CG). P_feedback may be P_CG multiplied by a factor. The factor is greater than zero. For example, P_feedback=M*P_CG. M is an integer greater than or equal to 1. For another example, P_feedback=M*P_CG. M is an integer greater than 0 and less than or equal to 1.

In some embodiments, the periodicity may be associated with a Frame per Second (FPS) of a traffic (P_FPS). For example, P_feedback=M/P_FPS. M is an integer greater than or equal to 1. For another example, P_feedback=M/P_FPS. M is an integer greater than 0 and less than or equal to 1.

The offset may be an offset from a reference point, or a duration between a reference point and a feedback information occasion. The offset may be in the unit of slot, mini slot, milliseconds, or symbols, etc. In some embodiments, the reference point is a start of a frame. In some embodiments, the reference point or the offset may be associated with at least one of the following: a DRX configuration, a SPS configuration, a CG configuration, a traffic arrival time. In some embodiments, the offset may be associated with a DRX configuration and the reference point may be a start of a frame. The offset may be the same as or larger than the offset of a DRX onduration and less than (offset of a DRX onduration+DRX onduration timer value). In some embodiments, the offset is associated with a SPS or CG configuration or a characteristic of the traffic, or the offset may be the duration between a feedback information occasion and a SPS PDSCH or CG-PUSCH transmission occasion. In some embodiments, the offset is associated with a SPS or CG configuration or a characteristic of the traffic, or the offset may be the minimum duration of a feedback information occasion and a SPS PDSCH transmission occasion, or the offset may be the minimum duration of a feedback information occasion and a CG-PUSCH transmit occasion. In some embodiments, a duration between A and B includes a duration between the end of A and the start of B. In some embodiments, a duration between A and B includes a duration between the start of A and the start of B.

The duration of the feedback information is number of symbols, slots, mini slots, or milliseconds allocated for feedback information transmission.

In some embodiments, the feedback information transmission occasion may be determined according a periodicity and an offset. For example, UE determines a feedback information transmission occasion in a PUCCH to be in a slot with number n_{f}^{μ} in a frame with number n_{f} if (n_{f}·Nₛₗₒₜ^{frame,μ}+n_{f}^{μ}−M_{offset})mod M_{periodicity}=0, μ is sub-carrier spacing configuration, Nₛₗₒₜ^{frame,μ} is number of slots per frame for the subcarrier spacing configuration μ, and n_{f} is System

Frame Number (SFN).

The SPS index (or configuration) is the index of the related SPS (e.g., the SPS associated with the transmission). The CG index (or configuration) is the index of the related CG (e.g., the CG associated with the transmission).

The PUCCH resource is the PUCCH resource in which the feedback information is transmitted.

In some embodiments, UE cannot transmit a feedback information if the prohibit timer is running. The unit of prohibit timer value includes slots or milliseconds.

In some embodiments, the prohibit timer is triggered after UE transmits a feedback information.

UE may transmit a feedback information in a transmission occasion. However, in some scenarios, such as if the prohibit timer is running, or if there is no change on channel condition, the UE may not transmit a feedback information.

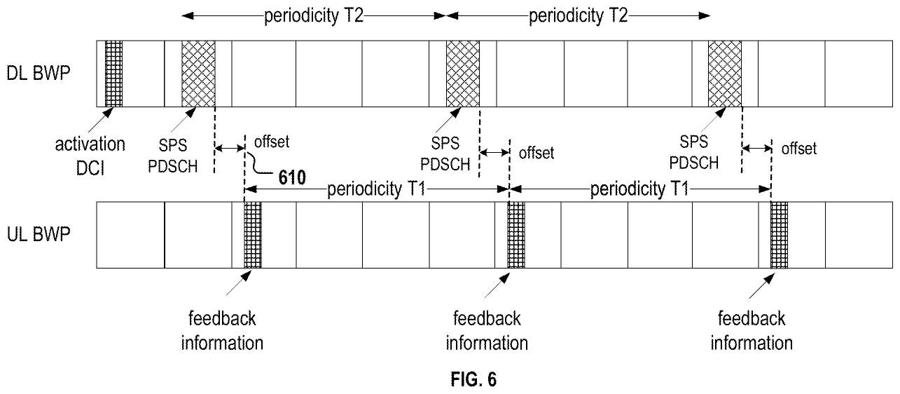

FIG. 6 shows an example configuration for the feedback information transmission. The offset 610 is a duration from the last symbol of a SPS PDSCH and the first symbol of a feedback information transmit occasion. The periodicity T1 of the feedback information is the same as the periodicity T2 of SPS PDSCH.

In some embodiments, the unit of offset is slot or symbol, and the corresponding SCS in which the feedback information is transmitted is the same SCS of the DL BWP in which a SPS PDSCH is transmitted, or the same SCS of the UL BWP in which a PUSCH is transmitted.

### Bit-Width

In some embodiments, the bit-width (number of bit) used for the feedback information may be associated with (or determined by) at least one of the following: number of SPS configurations, number of activated SPS configurations, an RRC signaling, number of SPS configurations which are related to a transmission control parameter adjustment configuration, number of SPS configurations which are related to a transmission control parameter adjustment configuration and are activated, a Hybrid Automatic Repeat reQuest (HARQ) information, number of CG configurations, number of activated CG configurations, a high layer signaling, or a group of CG configurations. A high layer signaling may include at least an RRC signaling or a MAC CE signaling. An RRC signaling may include a UE assistance information. In some embodiments, a group of CG configurations may include CG configurations which are related to a transmission control parameter adjustment configuration or activated CG configurations which are related to a transmission control parameter adjustment configuration.

In some embodiments, the bit-width of the feedback information may be associated with an RRC signaling. For example, the RRC signaling may configure a list of M delta values (or delta parameters). The bit-width may be determined by ┌log₂(M)┐. For another example, the RRC signaling may configure the bit-width directly.

In some embodiments, the bit-width of the feedback information may be associated with the number of activated SPS or CG configurations. For example, in slot n, the number of activated SPS or CG configurations is A, and the bit-width is A.

In some embodiments, the bit-width of the feedback information may be associated with the number of SPS and CG configurations. For example, in slot n, the number of SPS and CG configurations is A1, and the bit-width is A1.

In some embodiments, the bit-width of the feedback information may be associated with at least an RRC signaling, the number of SPS or CG configurations which are related to a transmission control parameter adjustment configuration and are activated. Or the bit-width may be determined by the total number of delta parameters in the feedback information. For example, there are two activated CG configurations, one is configured with 2 delta parameters and the other configured with 4 delta parameters, then the bit-width is ┌log₂(2)┐+┌log₂(4)┐=3.

In some embodiments, the bit-width of the feedback information may be associated with at least an RRC signaling and a HARQ information. For example, if the corresponding HARQ information is an acknowledgement (ACK), the bit-width is 0; otherwise, the bit-width is determined according to RRC signaling.

In some embodiments, the bit-width of the feedback information may be associated with at least an RRC signaling, a HARQ information, or the number of activated SPS which has transmission control parameter that needs to be updated. For example, for a particular SPS configuration, if the corresponding HARQ information is ACK, then bit-width for the corresponding SPS configuration is 0; otherwise, the bit-width for the related SPS configuration is determined according to the RRC signaling. The bit-width of the feedback information is the sum of the bit-width for every activated SPS configuration.

### How to Report Feedback Information

In some embodiments, the feedback information is reported associated or together with HARQ information. The feedback information bit may be prepended, appended, or interleaved with the HARQ bits.

Table 2 shows an example for allocating feedback information bits. There is a one to one correspondence between the HARQ information and the feedback information, based on the SPS index they are associated with.

TABLE 2
Example Feedback Information Position

| | | | | | |
|---|---|---|---|---|---|
| SPS 1 | SPS 2 | . . . | SPS 1 | SPS 2 | . . . |
| HARQ | HARQ | | feedback | feedback | |
| | | | information | information | |

Table 3 shows another example for allocating feedback information bits. In this example, the feedback information for all the SPSs are allocated together, and is appended with the HARQ information.

TABLE 3
Example Feedback Information Position

| | | | | |
|---|---|---|---|---|
| SPS 1 | SPS 2 | . . . | SPS feedback | . . . |
| HARQ | HARQ | | information | |

In some embodiments, if the feedback information includes feedback information for multiple SPS configurations, the feedback information may be ordered from the feedback information segment associated with a SPS with lowest order of HARQ to the feedback information segment associated with a SPS with highest order of HARQ. In another word, the order of the feedback information segments for the SPS is the same as the order of the SPS HARQ information. In some embodiments, the feedback information is ordered according to a BWP-Id and a SPS index. For each BWP-Id, the feedback information is ordered according to the related SPS index order, and the feedback information segment of each BWP is ordered according to the BWP index. In some embodiments, the feedback information is ordered according to a carrier index, the feedback information segment of each carrier is ordered according to the carrier index. In some embodiments, the feedback information is ordered according to a serving cell index, the feedback information segment of each serving cell is ordered according to the serving cell index.

In some embodiments, the order of feedback information for different SPS or CG configuration is indicated by an activation DCI.

In some embodiments, the feedback information for an SPS configuration is appended with the HARQ bits for the SPS PDSCH associated with the SPS configuration. See Table 4 below.

TABLE 4
Example Feedback Information Position

| | | | | |
|---|---|---|---|---|
| SPS 1 HARQ | SPS 1 | SPS 2 HARQ | SPS 2 | . . . |
| | feedback | | feedback | |
| | information | | information | |

In some embodiments, the SPS HARQ bit is jointly coded with the corresponding feedback information, if configured.

In some embodiments, UE may transmit feedback information separately via a UCI.

In some embodiments, the order of feedback information for different SPS configuration is indicated by an activation DCI.

In some embodiments, the order of feedback information for different CG configuration is indicated by an activation DCI.

In some embodiments, the order of feedback information for different SPS and CG configuration is indicated by an activation DCI.

### Resource for Reporting Feedback Information

The feedback information may be transmitted in a PUCCH or a PUSCH.

In some embodiments, the feedback information is transmitted in a PUCCH resource. The PUCCH resource is the PUCCH resource associated with at least one of the following: a HARQ resource for a SPS configuration, a PUCCH resource for a periodic- Channel Status Information (CSI) report, a PUCCH resource configured for a scheduling request (SR), a SPS configuration, or a specific PUCCH resource for a feedback information.

In some embodiments, the PUCCH resource may be the PUCCH resource associated with at least a HARQ resource for a SPS configuration. The feedback information shares resource with the HARQ transmission. In some embodiments, the PUCCH resource for the feedback information is immediately around the HARQ resource for a SPS configuration. In some embodiments, the PUCCH resource for the feedback information has the same configuration except the PUCCH-Resourceld.

In some embodiment, the PUCCH resource may be the PUCCH resource associated with at least a SPS configuration. This configuration enables the UE to transmit a feedback signaling associated with at least one SPS configuration. If there is no PUCCH resource configured for a feedback information, UE cannot transmit the feedback information.

In some embodiments, the PUCCH resource is a predetermined PUCCH resource configured for the feedback information.

In some embodiments, the format of the PUCCH resource includes at least one of PUCCH format 0, PUCCH format 1, PUCCH format 4, or PUCCH format 2. PUCCH format 0 and PUCCH format 2 occupy at most two symbols. PUCCH format 1 and PUCCH 4 occupy one Resource Block (RB) or one Physical Resource Block (PRB)). Therefore, the resource overhead of PUCCH format 0, PUCCH format 1, PUCCH format 4, or PUCCH format 2 is small.

In some embodiments, the PUCCH resource may be configured per BWP, per SPS, per logical channel, or per serving cell.

In some embodiments, the PUSCH resource may be a CG-PUSCH and the feedback information is transmitted in the CG-PUSCH.

### Multiplex

In a bit level, the feedback information may be multiplexed with various types of information, such as: scheduling request (SR), HARQ, CSI, etc. The multiplex may be done by appending, prepending, or interleaving the bit(s) of various type of information.

When UE performs uplink transmission scheduling for the feedback information, and there are other types of information to be transmitted in the same slot, UE may multiplex the feedback information the other types of information.

In some embodiments, if UE would transmit O_{delta} bit feedback information in first PUCCH resource and one positive SR in PUCCH format 0 or PUCCH format 1 in one slot, the one bit SR may be appended to the O_{delta} bit, and O_{inf}=O_{delta}+1 bits may be transmitted in the first PUCCH resource.

In some embodiments, in one slot, if UE would transmit one bit feedback information in first PUCCH resource with format 0 or format 1, and one positive SR in a second PUCCH resource with PUCCH format 0 or format 1, the one bit SR may be appended to the one bit feedback information, and these two bits may be transmitted in the first PUCCH resource.

In some embodiments, in one slot, if the UE would transmit a positive SR in a first resource using PUCCH format 1, and at most two bits feedback information in a second resource using PUCCH format 1, the UE transmits a PUCCH with feedback information bit in the first resource using PUCCH format 1. If the UE would not transmit a positive SR in a resource using PUCCH format 1 and would transmit at most two bits feedback information in a resource using PUCCH format 1 in a slot, the UE transmits a PUCCH in the resource using PUCCH format 1 for feedback information.

In some embodiments, if the UE would transmit O_{delta} bit feedback information in a first PUCCH resource and O_{ACK} bit HARQ information in a second PUCCH resource in one slot, the O_{delta} bit feedback information may be appended to the O_{ACK} HARQ information bit and the UE transmits the combined O_{inf}=O_{ACK}+O_{delta} bits in a PUCCH using a third PUCCH resource (e.g., via a UCI).

In some embodiments, the second PUCCH resource uses PUCCH format 2, PUCCH format 3, or PUCCH format 4. In some embodiments, the third PUCCH resource uses PUCCH format 2, PUCCH format 3, or PUCCH format 4. In some embodiments, the third PUCCH resource is the same as the second PUCCH resource.

In some embodiments, if the UE would transmit O_{delta} bit feedback information in a first PUCCH resource and O_{CSI} report information bit in a second PUCCH resource in one slot, the O_{delta} bit feedback information is prepended to the CSI report information bit and the UE transmits the combined O_{inf}=O_{delta}+O_{CSI} bits in a PUCCH using a third PUCCH resource.

In some embodiments, the second PUCCH resource uses PUCCH format 2, PUCCH format 3, or PUCCH format 4. In some embodiments, the third PUCCH resource uses PUCCH format 2, PUCCH format 3, or PUCCH format 4. In some embodiments, the third PUCCH resource is the same as the second PUCCH resource.

In some embodiments, if UE would transmit O_{delta} bit feedback information, O_{CSI} bit CSI report information, and O_{ACK} bit HARQ information in one slot, the O_{delta} feedback information bit is appended to O_{ACK} HARQ information bit, and the O_{CSI} report information bit is further appended to the O_{delta} bit of the feedback information.

In some embodiments, if UE would transmit O_{delta} bit feedback information and O_{SR} SR information bit and O_{ACK} HARQ information bit in one slot, the O_{delta} feedback information bit is appended to O_{ACK} HARQ information bit, and the O_{SR} information bit is further appended to O_{delta} bit of the feedback information.

In some embodiments, if UE would transmit O_{delta} bit feedback information, O_{SR} SR information bit, O_{ACK} HARQ information bit, and O_{CSI} report information bit in one slot, the O_{delta} bit feedback information is appended to O_{ACK} HARQ information bit, and the O_{SR} SR information bit is appended to O_{delta} bit feedback information, O_{CSI} CSI report information bit is further appended to O_{SR} information bit.

It is to be understood that the order of the bits operation such as append and prepend as described above is for exemplary purpose only, and maybe adjusted with no limitation.

In some embodiments, the information bit with high priority is in low index. For example, UCI bit sequence a₀, a₁, a₂, a₃, . . . , a_{A-1} starting with a₀. The most significant bit of each field is mapped to the lowest order information bit for that field, e.g. the most significant bit of the first field is mapped to a₀.

In some embodiments, the priority of information may follow this order: HARQ information bit>feedback information bit>SR information bit>CSI report information bit.

In some embodiments, the priority of information may follow this order: HARQ information bit>SR information bit>feedback information bit>CSI report information bit.

### Transmission Control Parameter Update Instruction

As illustrated in FIG. 4, after the base station receives the feedback information from the UE as an indication used for adjusting transmission control parameter, the base station makes a decision on the concerning parameter in step 405. In making the decision, the base station considers the feedback information, and may further consider other factors. The base station may choose to follow the recommendation from the UE, or it may make further adjustment due to other considerations.

In step 405, the base station determines the updated transmission control parameter. The base station sends a transmission control parameter update instruction to the UE in step 406 using, for example, a DCI, to inform the UE about the update that the UE needs to take.

### Content of Transmission Control Parameter Update Instruction

The transmission control parameter update instruction may include the updated transmission control parameter, such as an updated MCS index, an updated repetition number, an updated aggregation number, etc. The transmission control parameter update instruction may also include parameters defined in the transmission control parameter adjustment configuration as describe earlier. For example, the transmission control parameter update instruction may include a delta parameter, such as a delta MCS index, a delta CQI, a delta repetition number, a delta TCI, a delta SRI, etc., so UE can apply the delta parameter to derive the updated parameter.

In some embodiments, the transmission control parameter update instruction may include a delta parameter or a confirm information if a first condition is satisfied. The confirm information may be used to confirm the feedback information or recommended update. The first condition includes at least one of the following:
The last PDSCH is wrongly decoded;
The delta parameter is transmitted after an activation DCI;
An MCS index for the following (subsequent) PDSCH or PUSCH exists; or
The delta parameter is used for a PDSCH or PUSCH scheduling without a DCI.

In some embodiments, the transmission control parameter update instruction includes an MCS index if a second condition is satisfied. The second condition includes at least one of the following:
The DCI for transmitting the transmission control parameter update instruction is an activation DCI; or
The delta parameter is used for a PDSCH which is scheduled by an activation DCI.

In some embodiments, the transmission control parameter update instruction includes an MCS index, if the MCS index is used for PDSCH which is scheduled by an activation DCI. In some embodiments, the transmission control parameter update instruction includes a delta parameter or a confirm information, if the delta parameter is used for or is transmitted after a PDSCH which is scheduled without a DCI.

In some embodiments, the base station transmits a DCI to indicate an MCS index. the MCS index is determined according to the feedback information.

In some embodiments, the base station transmits a DCI to indicate an MCS index. The MCS index is determined according to at least one of the following: a reference MCS Index, a delta MCS Index, a delta CQI, an MCS Index percentage, a reference CQI, or a CQI.

In some embodiments, the MCS index is determined by at least a reference MCS Index and a delta MCS Index. For example, MCS_ID=MCS_ID_{ref}+MCS_ID_{mod}. MCS_ID is the MCS Index for following SPS PDSCH, MCS_ID_{ref} is a reference MCS ID, and MCS_ID_{mod} is a delta MCS ID.

In some embodiments, the MCS index is determined by at least a delta CQI and a reference CQI. For example, CQI=CQI_{ref}+CQI_{mod}. The CQI is used for following SPS PDSCH, CQI_{ref} is a reference CQI, CQI_{mod} is a delta CQI. In some embodiments, the base station may indicate an MCS index according to the CQI. In some embodiments, the reference CQI is a wideband CQI.

In some embodiments, MCS index is determined by at least an MCS index percentage. For example: MCS_ID=MCS_ID_{ref}*(1+MCS_ID_{percentage}). MCS_ID_{percentage} indicates a percentage of the update.

In some embodiments, TCI-state may be determined by at least a delta TCI. For example, a delta TCI in the feedback information is a delta value for codepoints of the DCI field “transmission configuration information”. The codepoints of the activation DCI field “transmission configuration information” is 01, the delta value is 1, then the update TCI-state is according to the codepoints which is 01+1=10 (bit operation).

In some embodiments, TCI-state is determined by at least a delta value for a TCI-state index.

In some embodiments, SRS resource index is determined by at least a delta value for an SRS resource indicator.

In some embodiments, the base station transmits a DCI to indicate a confirm information. The confirm information is used to indicate a UE whether the recommended parameter which the UE reports is used or not. For example, ‘0’ means the recommended parameter is not used (e.g., following SPS PDSCH will not use the recommended parameter), and ‘1’ means the recommended parameter is used (e.g., following SPS PDSCH will use the recommended parameter).

### DCI Configuration

In some embodiments, in step 406 of FIG. 4, the base station transmits the transmission control parameter update instruction via a message.

The DCI may be a compact DCI, which have less number of bits than DCI format 0_1 or DCI format 1_1 and may reduce the overhead signaling.

In some embodiments, the base station transmits a message to indicate a delta parameter or a percentage, such as a delta MCS index or an MCS ID percentage.

In some embodiments, the transmission control parameter update instruction includes at least one of the following: a delta parameter, a percentage, a PDCCH skipping indication, a search space set group switching indication, a minimum scheduling offset (e.g., minimum k0 or minimum k2) indication. A PDCCH skipping indication is used to indicate UE to skip or stop PDCCH monitoring for a duration. A search space set group switching indication is used to indicate a search space set group index.

In some embodiments, the transmission control parameter update instruction is joint coded. For example, the delta parameter is joint coded with a search space set group switching indication.

The message may be a DCI or a Demodulation Reference Signal (DMRS). In some embodiments, the transmission control parameter update instruction is transmitted via a DCI and a DMRS. For example, some bits of the transmission control parameter update instruction are transmitted via DCI and the others are transmitted via DMRS. In some embodiments, the transmission control parameter update instruction is transmitted via DMRS.

In some embodiments, the message includes a DMRS. The initialization for the scrambling sequence generator of DMRS may be associated with the transmission control parameter update instruction information.

In some embodiments, the delta parameter may be the same as the delta parameter indicated (or transmitted) by the feedback information.

For example, UE transmits a feedback information indicates a delta CQI, and the base station transmits a DCI with an updated MCS index. The updated MCS index is determined according to the delta CQI. The base station may also transmit a delta MCS index which is derived from the delta CQI indicated by the feedback information.

For another example, UE transmits a feedback information indicating a delta MCS index, and the base station transmits a DCI with a different delta MCS index. In some embodiments, the different modified MCS index is determined according to the delta MCS index indicated by the UE.

In some embodiments, the base station transmits a DCI to indicate a transmission control parameter update instruction if the base station successfully receives a feedback information.

In some embodiments, the base station does not transmit a DCI to indicate a transmission control parameter update instruction if the feedback information indicate a delta parameter is equal to 0 (no change on transmission parameter).

In some embodiments, the base station transmits a DCI to indicate a transmission control parameter update instruction if the base station successfully receives a feedback information and needs to indicate the UE not to apply the recommended update in feedback information.

### DCI Format

In some embodiments, the DCI for the carrying transmission control parameter update instruction includes at least one of the following: DCI format 0_1, DCI format 0_2, DCI format 1_1, DCI format 1_2, DCI format 2_0, DCI format 2_2, DCI format 2_3, or a group common DCI. A group common DCI is a DCI includes information for one or more UEs.

In some embodiments, the DCI is DCI format 2_2. The transmission control parameter update instruction for a UE is appended to the TPC command field. In some embodiments, the DCI is DCI format 2_2. In DCI format 2_2, the location index of a first bit of the transmission control parameter update instruction for a UE (or a BWP, or a serving cell) may be configured by a higher layer signaling (e.g., RRC signaling).

In some embodiments, the transmission control parameter update instruction is indicated in a first kind of field in a DCI.

In some embodiments, the first kind of field is available (i.e., available bits in the DCI is larger than zero) if an enable condition is satisfied. In some embodiments, base station may transmit a transmission control parameter update instruction if an enable condition is satisfied. The enable condition includes at least one of the following:
UE is configured to monitor a DCI with CRC scrambled by a first kind of RNTI;
A feedback information is configured by high layer signaling;
An enable signaling for the feedback information is configured;
An enable signaling for the transmission control parameter update instruction is configured;
A UE capability indicating that the UE supports the feedback information;
At least one SPS configuration or CG configuration is activated;
An RRC signaling is configured;
A transmission control parameter adjustment configuration is configured; or
A feedback information is received.

In some embodiments, the enable condition may be associated with at least one of the following: a feedback information; a Reference Signal Received Power (RSRP); a Channel State Information (CSI); a PDSCH without a corresponding PDCCH; a PUSCH without a corresponding PDCCH; a HARQ transmission number; a Negative-Acknowledge (NACK); a retransmission number; or a signaling.

In some embodiments, the base station may transmit a transmission control parameter update instruction if RSRP is less than a predefined threshold. The predefined threshold may be an integer. In some embodiments, the base station may transmit a transmission control parameter update instruction if a CSI information does not change. In some embodiments, the base station may transmit a transmission control parameter update instruction if a PDSCH without a corresponding PDCCH is transmitted. In some embodiments, the base station may transmit a transmission control parameter update instruction if a PUSCH without a corresponding PDCCH is received. In some embodiments, the base station may transmit a transmission control parameter update instruction if HARQ transmission number is greater than a second predefined threshold. The second predefined threshold is greater than 0 and less than 10. In some embodiments, the base station may transmit a transmission control parameter update instruction if receiving a NACK. In some embodiments, the base station may transmit a transmission control parameter update instruction if retransmission number is greater than a second predefined threshold. In some embodiments, the base station may transmit a transmission control parameter update instruction if a signaling is configured or received.

In some embodiments, if the first kind of field is used for the transmission control parameter update instruction, all the field in the DCI are set to zero except a second kind of field. In some embodiments, the second kind of field include at least one of the following: Identifier for DCI formats field, Carrier indicator field, downlink feedback information (DFI) flag field, HARQ-ACK bitmap field, Modulation and coding scheme field.

In some embodiments, if the first kind of field is used for the transmission control parameter update instruction, all the fields except a second kind of field in the DCI are set to zero and the bit-width is set to the smallest value which is available for the field.

The first kind of field includes at least one of the following: a DFI flag field; a Modulation and Coding Scheme field; a time domain resource assignment field; a new data indicator field; a redundancy version field; a HARQ process number field; an antenna port(s) field; a DMRS sequence initialization field; a transmission configuration indication field; a TPC command for scheduled PUSCH field; an SRS resource indicator field; a HARQ ACK field; or a predetermined field. In some embodiments, the predetermined field is a specific field used for the transmission control parameter update instruction. In some embodiments, the predetermined field is a new filed for transmission control parameter update instruction.

In some embodiments, the interpretation (or usage) of the field may be reinterpreted for the transmission control parameter update instruction.

In some embodiments, the first kind of field includes at least one of: a DFI field, or a modulation and coding scheme field. The DFI flag field is reinterpreted to be used to indicate whether the DCI is used to the activate or release a SPS configuration, or used to indicate if the DCI carries a transmission control parameter update instruction. If the DFI flag field indicates the DCI is used to carry the transmission control parameter update instruction, then the transmission control parameter update instruction may be carried in the modulation and coding scheme field.

In some embodiments, the first kind of field includes a predetermined field and a modulation and coding scheme field. The predetermined field is used to indicate whether the DCI is used to the activate or release a SPS configuration, or used to indicate a transmission control parameter update instruction. If the DCI is used to indicate a transmission control parameter update instruction, the transmission control parameter update instruction may be carried in the modulation and coding scheme field.

In some embodiments, the DCI which indicates a transmission control parameter update instruction is scrambled by a first kind RNTI. In some embodiments, the first kind RNTI includes at least one of the following: a CS-RNTI, a pre-determined RNTI used for indicating a transmission control parameter update instruction, an MCS-C-RNTI, or a C-RNTI. In some embodiments, the pre-determined RNTI is used for transmission control parameter update instruction.

In some embodiments, the DCI which indicates a transmission control parameter update instruction is associated with a search space set configuration.

The search space set configuration may be associated with at least one of the following: a feedback information configuration, a SPS configuration, a traffic parameter, a search space set for an activation DCI, or a CG configuration.

In some embodiments, a search space set configuration is associated with a SPS configuration. The periodicity (P_DCI) of the search space set is determined by a periodicity (P_SPS) of the SPS configuration and a factor. The factor is greater than zero. For example, P_DCI=M*P_SPS. M may be an integer greater than or equal to 1, or an integer greater than 0 and less than or equal to 1.

In some embodiments, the search space set configuration is associated with a CG configuration. The periodicity (P_DCI) is associated with a periodicity (P_CG) of a CG configuration. P_DCI is determined by a P_CG and a factor. The factor is greater than zero. For example, P_DCI=M*P_CG. M may be an integer greater than or equal to 1, or an integer greater than 0 and less than or equal to 1.

In some embodiments, the search space set configuration is associated with a traffic parameter. The periodicity (P_DCI) is associated with a speed (e.g., frames per second) (P_FPS) of a traffic. For example, P_DCI=M/P_FPS. M may be an integer greater than or equal to 1, or an integer greater than 0 and less than or equal to 1.

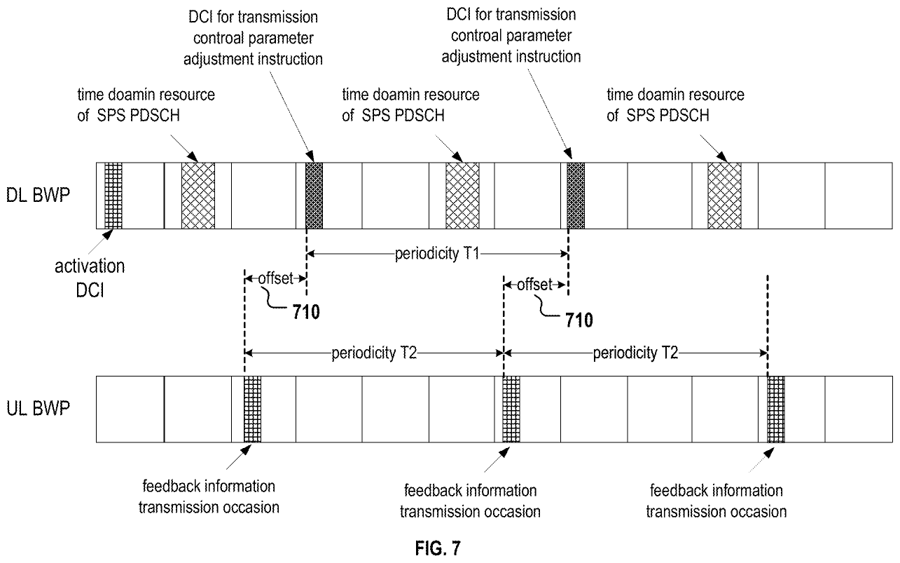

Referring to FIG. 7, in some embodiments, the search space set configuration is associated with a feedback information configuration. For example, the periodicity T1 of the search space set configuration is the same as the periodicity T2 of the feedback information transmission occasion. In some embodiments, the search space set configuration includes an offset. In some embodiments, the offset 710 is determined according to the offset with respect to a feedback information configuration. For example, the offset may be the offset between the search space set and a feedback information transmit occasion. In some embodiments, the offset may be the duration between the last slot (or symbol) of feedback information transmit occasion and the first slot (or symbol) of search space set.

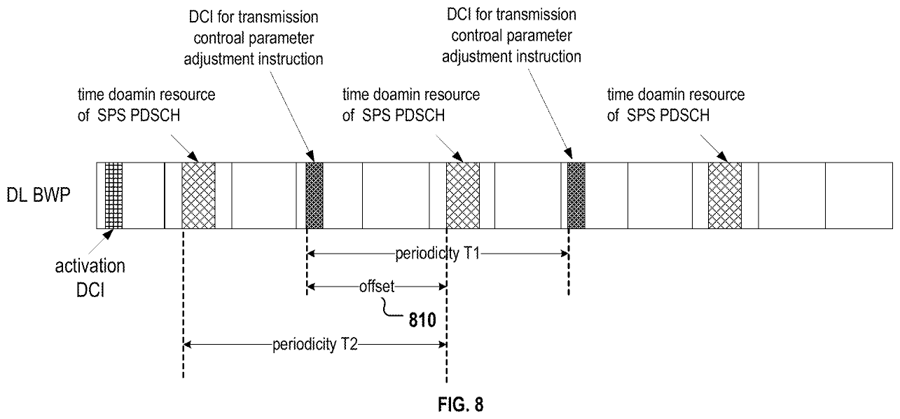

Referring to FIG. 8, in some embodiments, the search space set configuration is associated with a SPS configuration. For example, the periodicity T1 of the search space set configuration is the same as the periodicity T2 of the SPS configuration. In some embodiments, the search space set configuration includes an offset 810. In some embodiments, the offset 810 is determined according to the offset of a time domain resource of SPS. For example, the offset 810 is the offset between the search space set and a time domain resource of SPS. In some embodiments, the offset may be the duration between the last slot (or symbol) of search space set and the first slot (or symbol) of a SPS PDSCH. In some embodiments, the offset may be the duration between the last slot (or symbol) of search space set and the first slot (or symbol) of a CG PUSCH.

In some embodiments, the offset may be the duration between the last slot (or symbol) of search space set for an activation DCI and the first slot (or symbol) of a search space set for transmission control parameter update instruction.

In some embodiments, the search space set configuration is associated with a traffic parameter. The traffic parameter may include: FPS, packet size, periodicity, and priority. For example, the periodicity of search space set configuration is same as the periodicity of the traffic. The periodicity of the traffic may be derived from the FPS.

### Other Considerations

### Transmission Control Parameter Applying Occasions

In some embodiments, after UE transmits a feedback information, the base station does not need to transmit a confirmation or update to the UE. For example, UE may apply the recommended update directly once after transmitting the feedback information.

In some embodiments, the UE may enable or effectuate the update transmission control parameter after a delay. The delay may be associated with at least one of the following: a N1, a N2, a SCS, a k0, a k2, a k1, a timer, a k0min, a k2min, a frequency range (FR) type, a PDSCH decoding procedure time, a PUSCH preparation procedure time, a UE capability, or a predefined value.
K0min: minimum slot offset between a DCI and its scheduled PDSCH.
K2min: minimum slot offset between a DCI and its scheduled PUSCH.
K0: slot offset between a DCI and its scheduled PDSCH.
K2: slot offset between a DCI and its scheduled PUSCH.
K 1: slot offset between a PDSCH slot and a HARQ-ACK slot.
N1: PDSCH decoding time.
N2: PUSCH preparation time.
PDSCH decoding procedure time.
PUSCH preparation procedure time.
A FR type includes FR1 or FR2.

A PDSCH decoding procedure time is a minimum time duration from the end of the last symbol of the PDSCH carrying a transport block (TB) being acknowledged and the first uplink symbol of the PUCCH which carries the HARQ-ACK information.

A PUSCH preparation procedure time is a minimum time duration from the end of the reception of the last symbol of a PDCCH carrying a DCI scheduling a PUSCH and the first uplink symbol in the PUSCH allocation for the transport block.

The delay may be a duration between the last symbol of the feedback information and the effectuation time of the feedback information.

In some embodiments, the delay may be a different value for different FR type. For example, the value of delay for FR 1 is smaller than or equal to the value of delay for FR 2.

In some embodiments, the delay may be a different value for different SCS. For example, the value of delay for a larger SCS is greater than or equal to the value of delay for a smaller SCS. In some embodiments, the value of delay for different SCS or FR type is predefined.

In some embodiments, the delay may be controlled a timer. For example, if UE does not receive a DCI with transmission control parameter adjustment instruction before the timer expire, the recommended update in the feedback information is applied.

In some embodiments, the delay may be associated with a SCS. For example, different SCSs correspond with different delay. For another example, the delay needs to be changed according to SCS of a DL BWP and a SCS of a UL BWP. For another example, the delay is defined as M slots in UL BWP, after the UE transmits the feedback information with indication of updated MCS ID a SPS PDSCH, the updated MCS ID should be applied if the duration between the PDSCH and feedback indication is larger than

$$⌈ M \cdot \frac{{2}^{{μ}_{D L}}}{{2}^{{μ}_{U L}}} ⌉ ,$$

μ_{DL} is the SCS configuration of a DL BWP in which the SPS PDSCH is transmitted, μ_{UL} is the SCS configuration of a UL BWP in which the feedback information is transmitted,

In some embodiments, after UE transmits a feedback information, the base stations may transmit a transmission control parameter update instruction to UE.

In some embodiments, the update recommended in the feedback information is applied right after receiving a DCI with confirm information, or the next slot after receiving a DCI with a confirm information.

In some embodiments, the transmission control parameter update instruction is applied after a delay. The delay is associated with at least one of the following: N1, k0, k2, N2, k0min, k2min, k1, a timer, a SCS, a PDSCH decoding procedure time, a PUSCH preparation procedure time, a UE capability, or a predefined value.

In some embodiments, the transmission control parameter update instruction is applied means that the transmission control parameter update instruction used directly. In some embodiments, the transmission control parameter update instruction is applied means that the MCS ID of the SPS PDSCH or CG-PUSCH should be determined according to the transmission control parameter update instruction. In some embodiments, the transmission control parameter update instruction is applied means that the repetition number of the SPS PDSCH or CG-PUSCH is the one which is indicated by the DCI.

### Feature Activation for Feedback Information and Feedback Information Response

In some embodiments, UE can transmit a feedback information if a third condition is satisfied. The third condition include at least one of the following:
An RRC signaling include configuration information for a feedback information is sent;
An RRC signaling includes configuration information of a modified (or delta) parameter is sent;
An enable signaling for UE to transmit a feedback information is sent; or
A SPS session or CG session is activated, or a SPS configuration or a CG configuration is activated.

In some embodiments, the base station can transmit a transmission control parameter update instruction if a forth condition is satisfied. The forth condition include at least one of the following:
A search space set for the DCI carrying a transmission control parameter update instruction is configured;
A DCI is configured;
A feedback information is received;
An RRC signaling includes configuration information of a modified (or delta) parameter is configured is sent;
A SPS session or CG session is activated, or a SPS configuration or a CG configuration is activated; or
An enable signaling for base station to transmit a transmission control parameter update instruction is sent.

In some embodiments, the third condition and the forth condition can be considered as an enable condition.

### Feature Cancel or Deactivation for Feedback Information

In some embodiments, the base station may send a DCI indicating cancel (or stop, or disable) the transmit of feedback information.

In some embodiments, UE may send a UL signal indicating cancel (or stop, or disable) the transmit of feedback information.

The UL signal include at least one of the following: a UCI, a MAC signaling, a HARQ information, a SR (scheduling request), a BSR (buffer status report), a PUSCH.

Cancel (or stop or disable) the transmission of the feedback information means that the UE cannot transmit a feedback information in the transmit occasion.

In some embodiments, if UE is indicated or indicates cancel the transmit of feedback information, the UE will no longer monitor a DCI with transmission control parameter adjustment instruction.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method performed by a wireless terminal comprising:
transmitting feedback information to a wireless communication node via a first message, wherein:
the feedback information is used for adjusting a transmission control parameter for a transmission associated with the wireless terminal;
the transmission comprises at least one of a semi persistent scheduling (SPS) transmission or a configured grant (CG) scheduling transmission; and
the transmission control parameter comprises at least one of:
a modulation and coding scheme (MCS) index;
a modulation order;
a repetition number;
an aggregation number;
transmission configuration information (TCI);
a sounding reference signal (SRS) resource indicator (SRI); or
a TCI state.

2. (canceled)

3. The method of claim 1, wherein transmitting the feedback information to the wireless communication node comprises:
in response to an enable condition, transmitting the feedback information to the wireless communication node, wherein the enable condition comprises receiving an indication from the wireless communication node via a radio resource control (RRC) message or a Downlink Control Information (DCI), or the enable condition is associated with at least one of:
a Signal to Noise or Interference Ratio (SINR);
a Reference Signal Received Power (RSRP);
a Channel State Information (CSI) information;
a trigger signaling;
a Physical Downlink Shared Channel (PDSCH) reception without a corresponding Physical Downlink Control Channel (PDCCH);
a Physical Uplink Shared Channel (PUSCH) without a corresponding PDCCH;
a block error rate (BLER);
a HARQ transmission number;
a Negative-Acknowledge (NACK); or
a retransmission number.

4. The method of claim 1, wherein the feedback information is based on transmission control parameter adjustment configuration, the transmission control parameter adjustment configuration comprising at least one of:
a delta value;
a percentage value;
a step; or
a fallback information.

5. The method of claim 4, wherein the transmission control parameter adjustment configuration is predetermined or received from the wireless communication node via a high layer signaling.

6. (canceled)

7. The method of claim 4, wherein the transmission control parameter adjustment configuration is associated with at least one of:
an MCS index;
a channel quality information (CQI);
an aggregation number of physical downlink shared channel (PDSCH) or physical uplink shared channel (PUSCH);
a repetition number;
a TCI;
a SRI; or
at least one SPS identifier or CG identifier, each of the at least one SPS identifier identifying an SPS transmission, each of the at least one CG identifier identifying an CG transmission.

8-10. (canceled)

11. The method of claim 1, wherein transmitting the feedback information to the wireless communication node comprises transmitting the feedback information to the wireless communication node according to at least one of:
a periodicity of a transmission of the feedback information;
an offset of the transmission of the feedback information relative to a reference point;
the reference point;
a physical uplink control channel (PUCCH) resource for the feedback information;
a prohibit timer;
a duration of the transmission of the feedback information;
a configuration of an SPS transmission; or
a configuration of a CG transmission, wherein the periodicity is based on at least one of:
a discontinuous reception (DRX) cycle;
a periodicity of the SPS transmission;
a periodicity of the CG transmission;
a frame per second (FPS); or
a higher layer signaling, and wherein the reference point or the offset is associated with at least one:
a DRX configuration;
the configuration of the SPS transmission;
the configuration of the CG transmission;
a PDSCH;
a PUSCH; or
an arrival time of a traffic for a service.

12-13. (canceled)

14. The method of claim 11, wherein before transmitting the feedback information to the wireless communication node, the method further comprises
determining a transmission occasion for transmitting the feedback information based on the periodicity of the transmission of the feedback information and the offset of the transmission of the feedback information relative to the reference point.

15. The method of claim 1, wherein a number of bits allocated for transmitting the feedback information is associated with at least one of:
a number of SPS configurations;
a number of SPS configurations associated with a transmission control parameter adjustment configuration;
a number of activated SPS configurations;
a number of activated SPS configuration associated with the transmission control parameter adjustment configuration;
hybrid automatic repeat request (HARQ) information associated with the transmission;
a number of CG configurations;
a number of activated CG configurations associated with the transmission control parameter adjustment configuration;
a high layer signaling; or
a group of CG configurations.

16. The method of claim 1, wherein a location of the feedback information in the first message is associated with HARQ information comprising at least one HARQ information segment, each of the at least one HARQ information segment corresponding to an SPS configuration.

17. The method of claim 16, wherein the feedback information comprises at least one segment, each of the at least one segment corresponding to an SPS configuration and being associated with a HARQ information segment which is associated with the same SPS configuration, and wherein an order of the at least one segment is determined by:
an order of the at least one HARQ information segment;
a Bandwidth Part (BWP) index;
a SPS index;
a carrier index; or
an activation DCI which activates the wireless terminal to transmit the feedback information.

18. The method of claim 16, wherein the feedback information comprises at least one segment, each of the at least one segment corresponding to an SPS configuration and being jointly coded with a HARQ information segment which is associated with the same SPS configuration.

19. The method of claim 1, wherein the feedback information comprises at least one segment, each of the at least one segment corresponding to an SPS configuration or a CG configuration, and wherein an order of the at least one segment is determined by one of:
an activation DCI which activates the wireless terminal to transmit the feedback information;
a SPS index;
a carrier index; or
a BWP index.

20-32. (canceled)

33. A method performed by a wireless communication node, comprising:
receiving feedback information from a wireless terminal via a first message, wherein: the feedback information is based on transmission control parameter adjustment configuration.
the feedback information is based on transmission control parameter adjustment configuration;
the transmission control parameter comprises at least one of:
a modulation and coding scheme (MCS) index;
a modulation order;
a repetition number;
an aggregation number;
transmission configuration information (TCI);
a sounding reference signal (SRS) resource indicator (SRI); or
a TCI state; and
the transmission associated with the wireless terminal comprises at least one of an SPS transmission or a CG scheduling transmission.

34-35. (canceled)

36. The method of claim 33, wherein:
before receiving the feedback information from the wireless terminal, the method further comprises:
transmitting the transmission control parameter adjustment configuration to the wireless terminal via a second message, the transmission control parameter adjustment configuration comprising at least one of:
a delta value;
a percentage value;
a step; or
a fallback information;
the second message comprises an RRC message; and
a granularity of the transmission control parameter adjustment configuration comprises one per SPS configuration;
per SPS configuration;
per CG configuration;
per BWP configuration;
per medium access control (MAC) configuration;
per UE configuration; or
per cell configuration.

37-38. (canceled)

39. The method of claim 33, further comprising:
transmitting a third message to the wireless terminal, the third message comprising transmission control parameter update instruction, the transmission control parameter update instruction comprising at least one of:
an updated transmission control parameter;
a confirm information; or
transmission control parameter adjustment information, wherein the third message comprises one of a DCI or a Demodulation Reference Signal (DMRS).

40-42. (canceled)

43. The method of claim 39, further comprising in response to an enable condition, transmitting a third message to the wireless terminal, wherein the enable condition is associated with at least one of:
a feedback information;
a Reference Signal Received Power (RSRP);
a Channel State Information (CSI) information;
a PDSCH without a corresponding PDCCH;
a PUSCH without a corresponding PDCCH;
a HARQ transmission number;
a signaling;
a UE capability;
a Negative-Acknowledge (NACK); or
a retransmission number.

44. The method of claim 39, wherein the DCI is associated with a search space set configuration, and the search space set configuration is associated with at least one of:
a configuration of the feedback information;
an SPS configuration associated with the transmission;
a CG configuration associated with the transmission;
a search space set for an activation DCI; or
a traffic control parameter associated with the transmission.

45-46. (canceled)

47. A wireless device comprising a memory for storing computer instructions and a processor in communication with the memory, wherein, when the processor executes the computer instructions, the processor is configured to cause the wireless device to:
transmit feedback information to a wireless communication node via a first message, wherein:
the feedback information is used for adjusting a transmission control parameter for a transmission associated with the wireless terminal;
the transmission comprises at least one of a semi persistent scheduling (SPS) transmission or a configured grant (CG) scheduling transmission; and
the transmission control parameter comprises at least one of:
a modulation and coding scheme (MCS) index;
a modulation order;
a repetition number;
an aggregation number;
transmission configuration information (TCI);
a sounding reference signal (SRS) resource indicator (SRI); or
a TCI state.

48. A computer program product comprising a non-transitory computer-readable program medium with computer code stored thereupon, the computer code, when executed by one or more processors, causing the one or more processors to implement a method of claim 1.

49. A wireless communication node comprising a memory for storing computer instructions and a processor in communication with the memory, wherein the processor, when executing the computer instructions, is configured to implement a method of claim 33.
